(19) United States
(12) Patent Application Publication
(10) Pub. No.: US 2018/0356558 A1
(43) Pub. Date: Dec. 13, 2018

(54) METHOD FOR DETECTING THE PRESENCE OR ABSENCE OF AN OPHTHALMIC LENS WITHIN A RECEPTACLE

(71) Applicant: Novartis AG, Basel (CH)

(72) Inventor: Rene Ochrombel, Bergheim (DE)

(21) Appl. No.: 16/002,056

(22) Filed: Jun. 7, 2018

Related U.S. Application Data
(60) Provisional application No. 62/516,928, filed on Jun. 8, 2017.

(51) Int. Cl. G01V 8/12

(52) U.S. Cl. CPC G01V 8/12; A45C 11/005

(57) ABSTRACT

The present invention relates to a method and a lens detection station for detecting the presence or absence of an ophthalmic lens capable of absorbing UV-light, in particular a contact lens, in a receptacle. The method comprises the steps of:
irradiating at least a portion of said receptacle where said ophthalmic lens is supposedly accommodated with UV-light, said receptacle having an absorbance for said UV-light which is significantly different from that of the ophthalmic lens,
detecting UV-light coming from said irradiated portion of said receptacle where said ophthalmic lens is supposedly accommodated,
analyzing said detected UV-light, and
from said analysis of said detected UV-light determining the presence or absence of a said ophthalmic lens.

### FIELD OF THE INVENTION

The invention relates to a method and a lens detection station for detecting the presence or absence of an ophthalmic lens capable of absorbing UV-light, in particular a contact lens, within a receptacle.

### BACKGROUND OF THE INVENTION

Ophthalmic lenses, in particular contact lenses, are nowadays produced in great volumes in highly automated manufacturing lines. In a packaging station of such manufacturing line the contact lens is placed into a receptacle for the final contact lens packaging. Usually saline is added into the receptacle and a removable cover is placed, for example laminated, onto the top surface of the receptacle to form a liquid-tight closure of the receptacle containing the contact lens in the saline. The package is then ready for storage and shipment.

During contact lens packaging, in a final detection step it is ascertained that a contact lens is present in the receptacle of the contact lens package. An example of such method for detecting whether or not a contact lens is present within a receptacle is performed by passively detecting a portion of the infrared spectrum of the light coming from the receptacle supposedly containing the contact lens with the aid of an infrared camera, as this is disclosed in WO 2016/038056.

Even though this method is suitable for detecting the presence or absence of a contact lens within the receptacle, due to the use of the infrared camera the technical expense to perform this kind of detection is comparatively high, and the IR-camera renders this method comparatively costly.

Contact lenses exhibiting a high absorption of UV-light have become available and prevent the visual abilities of a user from being adversely influenced by UV-light entering the eye through the pupil.

It is therefore an object of the invention to suggest an easy, reliable and inexpensive detection of the presence or absence of ophthalmic lenses having such UV-absorptive properties, in particular contact lenses, within a receptacle.

### SUMMARY OF THE INVENTION

These and other objects are achieved according to one aspect of the invention through a method as it is specified by the features of the independent method claim. Advantageous aspects of the method according to the invention are the subject of the dependent method claims. The objects are also achieved according to another aspect of the invention through a lens detection station as it is specified by the features of the independent claim directed to a lens detection station. Advantageous aspects of the lens detection station according to the invention are the subject of the dependent claims directed to the lens detection station.

As used in the specification including the appended claims, the singular forms “a”, “an”, and “the” include the plural, unless the context explicitly dictates otherwise. Also, whenever features are combined with the term “or”, the term “or” is to be understood to also include “and” unless it is evident from the specification that the term “or” must be understood as being exclusive.

In the present specification, the terms “upwardly/above” and “downwardly/beneath” are defined in relation to a top surface and a bottom surface of the receptacle. “Upwardly/above” describes a direction away from the top surface of the receptacle, and “downwardly/beneath” describes a direction away from the bottom surface of the receptacle.

Generally, different aspects can be combined with each other in any possible manner unless the specification dictates otherwise.

In accordance with one aspect of the invention, a method for detecting the presence or absence of an ophthalmic lens capable of absorbing UV-light, in particular a contact lens, in a receptacle is provided. The method comprises the following steps:
irradiating at least a portion of said receptacle where said ophthalmic lens is supposedly accommodated with UV-light, said receptacle having an absorbance for said UV-light which is significantly different from that of the ophthalmic lens,
detecting UV-light coming from said irradiated portion of said receptacle where said ophthalmic lens is supposedly accommodated,
analyzing said detected UV-light, and
from said analysis of said detected UV-light determining the presence or absence of a said ophthalmic lens in said receptacle.

In accordance with one aspect of the method according to the invention, the method further comprises the step of irradiating said portion of said receptacle with radiation comprising UV-light of a wavelength in the range of 280 nm to 380 nm.

In accordance with a further aspect of the method according to the invention, the step of irradiating is performed using a UV-laser.

In accordance with still a further aspect of the method according to the invention, the step of detecting UV-light is performed using a detector capable of detecting said UV-light of a wavelength in the range of 280 nm to 380 nm. Said step of analyzing said detected UV-light comprises comparing the intensity of said detected UV-light of a wavelength in the range of 280 nm to 380 nm detected by said detector with a predefined threshold. In case the intensity of said detected UV-light of a wavelength in the range of 280 nm to 380 nm detected by said detector is less than said predefined threshold the presence of said ophthalmic lens is determined.

Yet in accordance with a further aspect of the method according to the invention, the step of irradiating said portion of said receptacle with the said UV-light and said step of detecting said UV-light coming from the said irradiated portion of said receptacle are performed with said receptacle being filled with a liquid.

In accordance with a further aspect of the method according to the invention, said receptacle is irradiated with said UV-light from beneath a bottom of said receptacle or from above a top surface of said receptacle. Said UV-light coming from said portion of said receptacle is detected on a side of said receptacle opposite to that side from which said portion of said receptacle is irradiated.

In accordance with still a further aspect of the method according to the invention, a removable cover which is non-transparent to said UV-light is attached to a top surface of said receptacle. Both, said step of irradiating said portion of said receptacle with said UV-light as well as said step of detecting said UV-light coming from said irradiated portion of said receptacle are performed from beneath a bottom of said receptacle.

Yet in accordance with a further aspect of the method according to the invention, said receptacle is made of polypropylene.

In accordance with another aspect of the invention, a lens detection station for detecting the presence or absence of an ophthalmic lens capable of absorbing UV-light, in particular a contact lens, in a receptacle is provided. The lens detection station comprises a UV-light source which is arranged to in operation irradiate with UV-light at least a portion of said receptacle where said ophthalmic lens is supposedly accommodated. The lens detection station further comprises a detector capable of and arranged to in operation detect UV-light coming from said portion of said receptacle where said ophthalmic lens is supposedly accommodated. The detector is further adapted to analyze said detected UV-light and to determine from said analysis the presence or absence of a said ophthalmic lens in said receptacle.

In accordance with one aspect of the lens detection station according to the invention, said UV-light source is adapted to in operation irradiate said portion of said receptacle with UV-light of a wavelength in the range of 280 nm to 380 nm. The detector is capable of detecting UV-light of a wavelength in said range of 280 nm to 380 nm.

In accordance with a further aspect of the lens detection station according to the invention, said UV-radiation source is a UV-laser.

One advantage of the method and lens detection station according to the invention is to allow for detecting the presence or absence of an ophthalmic lens which is capable of absorbing UV-light in a receptacle having an absorbance for UV-light which is significantly different from that of the ophthalmic lens in a reliable, technically inexpensive and cost-saving manner. In essence, only a UV-radiation source and a detector capable of detecting and analyzing the UV-light coming from the receptacle are needed.

As mentioned already, the ophthalmic lens is capable of absorbing UV-light. The term “capable of absorbing UV-light” is to be understood such, that the ophthalmic lens is at least capable of absorbing a substantial portion of UV-light having an intensity of 100 mW/cm² or less over the entire wavelength range of UV-light (10 nm-380 nm). However, it is not required that the capability of the ophthalmic lens to absorb UV-light (absorbance) is uniform over the entire wavelength range of UV-light. For example, at the above-identified intensity and at a wavelength in the UV-B range (i.e. in the wavelength range of 280 nm-315 nm) the ophthalmic lens may practically completely absorb the UV-light (absorbance is at least 99%). At the above-identified intensity and a wavelength in the UV-A range (i.e. in the wavelength range of 315 nm-380 nm), the ophthalmic lens may absorb a very substantial portion of the UV-light (at least 80%). In order to take advantage of the absorptive properties of the ophthalmic lens in detecting the presence or absence of the ophthalmic lens, it is necessary that the irradiating UV-light passes through the receptacle and the supposedly accommodated ophthalmic lens before the UV-light is detected. Thus, the UV-light source used for the irradiation must be arranged such that the UV-light irradiates at least a portion of the receptacle where the ophthalmic lens is supposedly accommodated. Likewise, the detector must be arranged such that it detects UV-light coming from the said portion of the receptacle where the ophthalmic lens is supposedly accommodated, so that the UV-light coming from the receptacle has passed through the ophthalmic lens (if present) before it is detected. The intensity of the UV-light received by the detector is then indicative of whether or not an ophthalmic lens is present in the receptacle.

By way of example, the UV-light source is a UV-laser (e.g. embodied as a diode laser which is readily available on the market). This allows for irradiating the receptacle with UV-light having a specific wavelength (as UV-lasers are practically monochromatic). Therefore, when detecting UV-light coming from the receptacle, only UV-light having the specific wavelength of the UV-light generated by the UV-laser has to be detected and analyzed. This facilitates separation of UV-light which is relevant for the analysis from light which is irrelevant for the analysis and subsequent determination of whether or not an ophthalmic lens is present in the receptacle.

By way of example again, the UV-light source may generate UV-light having a wavelength in the range of 280 nm to 380 nm (i.e. a wavelength in the wavelength range of UV-B or UV-A). This allows for detecting and analyzing the UV-light in a wavelength range in which absorbance of the ophthalmic lens is high, since the purpose of this type of ophthalmic lens is to protect the eye from UV-light that may be contained, for example, in the sunlight, mainly UV-B and UV-A.

An important aspect is that the receptacle has an absorbance for UV-light which is significantly different from that of the ophthalmic lens. The term “significantly different” in this regard means that over the entire range of UV-light at the already mentioned intensity of 100 mW/cm² the receptacle must have an absorbance which is at least 40% less than the absorbance of the ophthalmic lens. Or to put it in simple words: the receptacle must be significantly more transparent to UV-light than the ophthalmic lens. The greater the difference between the absorbance of the ophthalmic lens and the absorbance of the receptacle, the easier is the detection whether or not an ophthalmic lens is present in the receptacle, as the difference in intensity of the UV-light coming from the receptacle and received by the detector is greater.

By way of example, the receptacle may be made of polypropylene which is more or less transparent to UV-light, as will be discussed in detail below when describing embodiments of the invention, with polypropylene being a material that allows for a cheap and reliable manufacturing of the receptacles through injection molding techniques. Thus, UV-light coming from the UV-light source and irradiating the receptacle in the portion where the ophthalmic lens is supposedly accommodated more or less passes through the receptacle without substantial portions of the UV-light being absorbed by the receptacle.

By way of example, the receptacle may be irradiated with UV-light from beneath a bottom of the receptacle or from above a top surface of the receptacle. Detection of the UV-light may be performed on a side opposite to that side from which the receptacle is irradiated. In other words, the UV-light source may be arranged above the top surface of the receptacle and the detector may be arranged beneath the bottom of the receptacle, or vice versa. In such an arrangement detection of the presence or absence of the ophthalmic lens is performed in transmission. Such arrangement can be used either in cases where no cover is arranged on the receptacle (e.g. no cover foil is laminated onto the top surface of the receptacle) or in cases where such cover (e.g. the cover foil) is transparent or substantially transparent to UV-light.

Alternatively, the receptacle may be irradiated with UV-light from beneath the bottom of the receptacle and detection of the UV-light may also be performed from beneath the bottom of the receptacle. This allows for performing the detection in cases in which a cover (e.g. the cover foil) which is non-transparent to UV-light is arranged on the top surface of the receptacle. The lens presence check may thus be performed at a very late stage of the packaging process after the lens has been placed into the receptacle, a storage and preservation liquid (such as saline) has been added, and the cover foil has been laminated to the top surface of the receptacle.

Analysis of the detected UV-light can be easily performed by comparing the intensity of the UV-light detected by the detector with a predefined threshold. In case the detected intensity is higher than the said threshold, absence of an ophthalmic lens is determined. In case the detected intensity is lower than the said threshold, presence of an ophthalmic lens is determined.

### BRIEF DESCRIPTION OF THE DRAWINGS

Further advantageous aspects of the invention become apparent from the following description of embodiments of the invention with the aid of the drawings in which:

FIG. 1 shows a method and lens detection station according to a first embodiment of the invention with no contact lens being present in the receptacle;

FIG. 2 shows the method and lens detection station according to FIG. 1 with a contact lens being present in the receptacle;

FIG. 3 shows a method and lens detection station according to a second embodiment of the invention with no contact lens being present in the receptacle;

FIG. 4 shows the method and lens detection station of FIG. 3 with a contact lens being present in the receptacle;

FIG. 5 shows a diagram representing the transmittance of polypropylene as a function of the wavelength;

FIG. 6 shows a diagram representing the absorbance of water as a function of the wavelength; and

FIG. 7 shows a diagram representing the transmittance of a contact lens as a function of the wavelength.

### DETAILED DESCRIPTION OF EMBODIMENTS

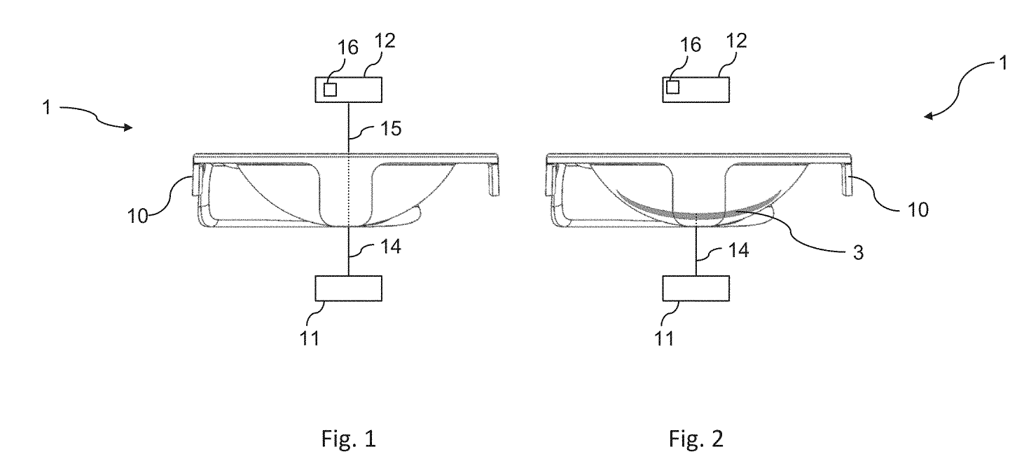

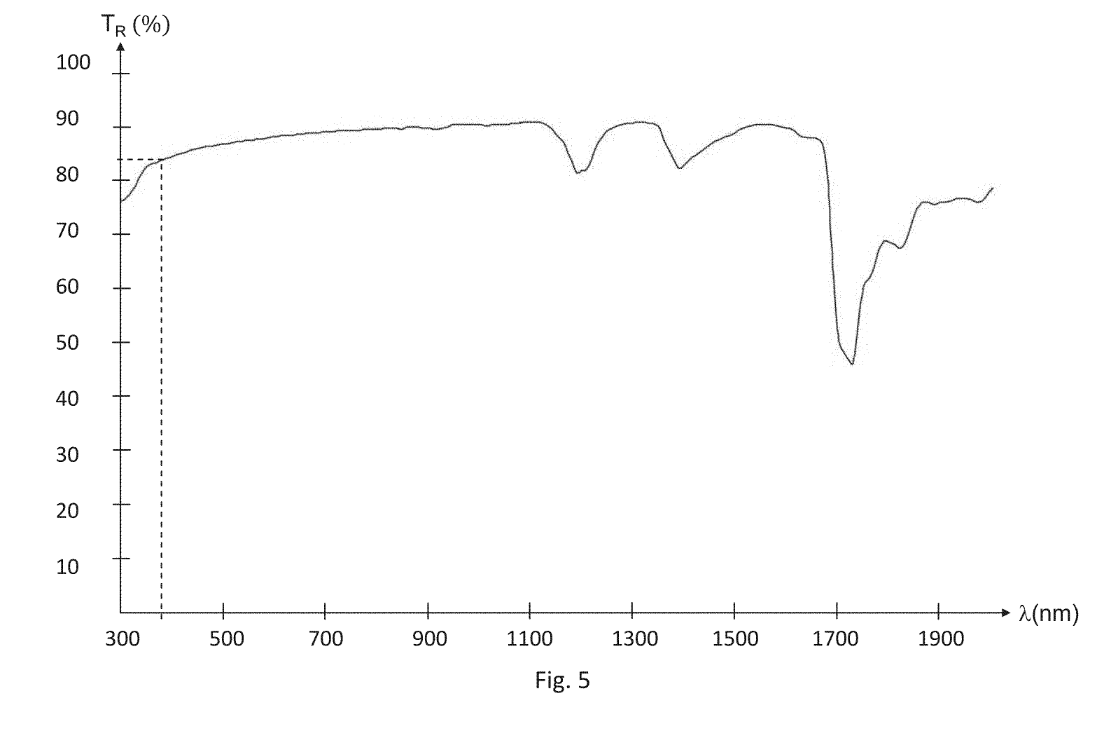

FIG. 1 and FIG. 2 illustrate a method and lens detection station 1 according to a first embodiment of the invention, the lens detection station 1 comprising a receptacle 10 for accommodating a contact lens 3, a UV-light source 11 and a detector 12 capable of detecting UV-light. A UV-diode laser may be used as UV-light source 11, for example the diode laser Stradus® 375-60 available from the company Vortran Laser Technology, Inc., Sacramento, Calif., U.S.A., providing UV-light at a wavelength of 375 nm, or can be a simple UV-laser diode. The receptacle 10 may be made of polypropylene and is more or less transparent to light over a broad wavelength range, including UV-light. FIG. 5 shows a diagram representing the transmittance T_{R} of the polypropylene receptacle to light in percentages as a function of the wavelength at an intensity of 1 W/cm², for example. As can be seen in FIG. 5, at a wavelength of 375 nm (UV-A range) the transmission T_{R} is about 84% (dashed vertical line indicating 375 nm and dashed horizontal line indicating about 84% T_{R}).

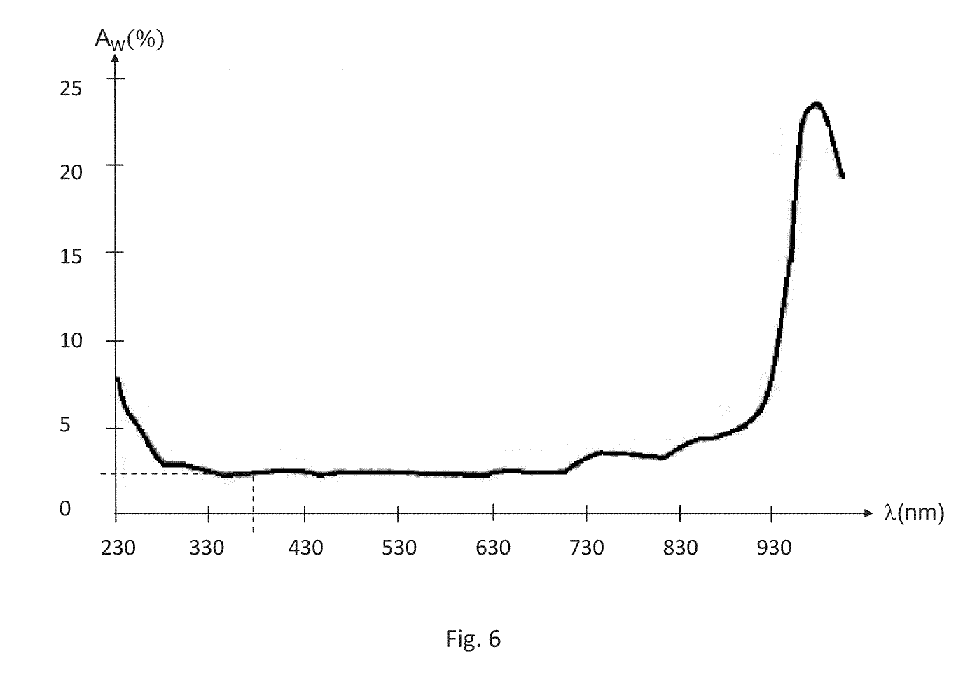

Although not mandatory, the receptacle 10 may be filled with a liquid, for example saline (which is mainly water containing a small amount of sodium chloride and some small amounts of preservatives). The absorbance of saline practically corresponds to the absorbance of water, at least for the purpose of the present invention. The absorbance Aw of water in percentages as a function of the wavelength is shown in the diagram of FIG. 6, and is representative for the absorbance of saline, at least for the purpose of the present invention. As can be seen in FIG. 6, and illustrated by the dashed lines, at the afore-mentioned wavelength of 375 nm (which is in the UV-A range) the absorbance A_{W} is about 2.5% corresponding to a transmission of about 97.5%.

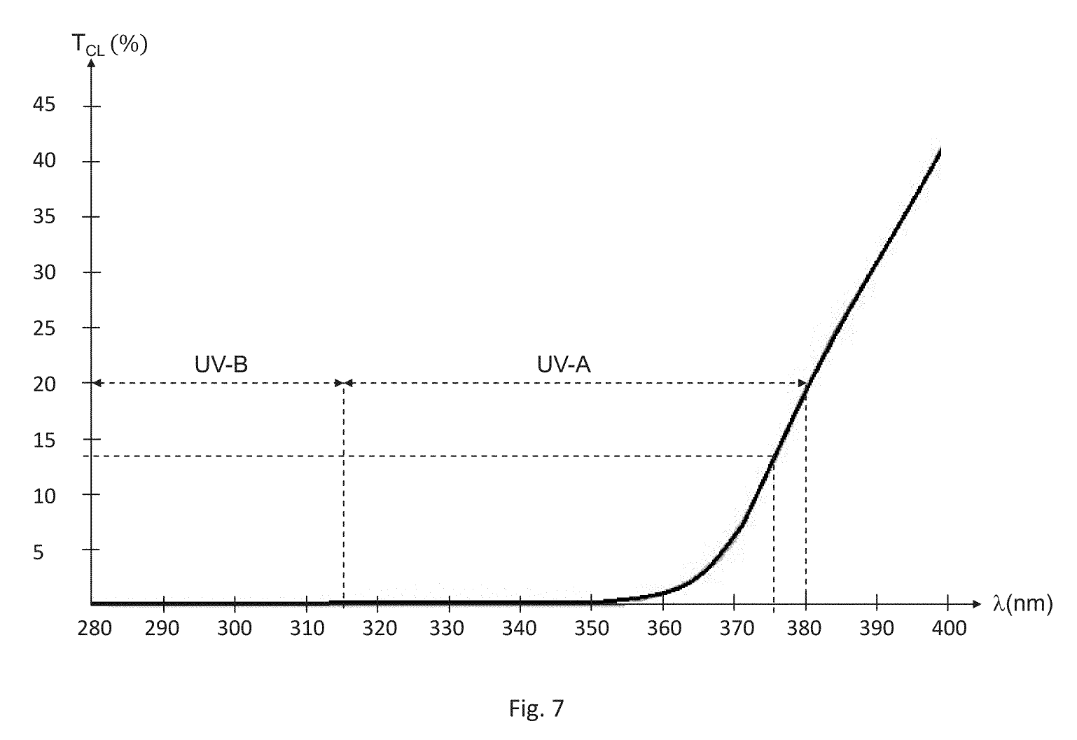

The diagram shown FIG. 7 represents the transmittance T_{CL} of the contact lens 3 as a function of the wavelength. As can be seen in FIG. 7 at the afore-mentioned wavelength of 375 nm (which is in the UV-A range) the transmission T_{CL} is about 13%. As can be seen further in FIG. 7, in the UV-B range (280 nm-315 nm) the transmission is practically zero, the UV-light of that wavelength range is practically completely absorbed by the contact lens 3.

The UV-light source 11 is arranged to in operation irradiate with UV-light 14 at least a portion of the receptacle 10 where the contact lens 3 is supposedly accommodated.

As shown in FIG. 1 and FIG. 2, the UV-light source 11 is arranged beneath a bottom of the receptacle 10 to irradiate the receptacle 10 from beneath. The detector 12 is arranged above a top surface of the receptacle 10 to detect UV-light 15 of the said wavelength of 375 nm coming from the irradiated portion of said receptacle 10 where the contact lens 3 is supposedly accommodated.

In case no contact lens 3 is present in the receptacle as is shown in FIG. 1, the detector 12 detects the intensity of the detected UV-light 15 that has passed through the irradiated portion of the receptacle 10, however, as there is no contact lens 3 contained in the receptacle 10, the intensity of the detected UV-light 15 is not reduced by such contact lens 3. In case a contact lens 3 is present in the receptacle, the intensity of the detected UV-light 15 is reduced as absorption by the contact lens 3 has occurred, or no detected UV-light 15 is detected by the detector 12 (in the case that all UV-light has been absorbed by the contact lens), as this is indicated in FIG. 2.

This difference in the intensity of the detected UV-light 15 can be readily determined by an evaluation component 16 of the detector 12. The evaluation component 16 analyzes the intensity of the detected UV-light 15 and, from the intensity of the detected UV-light 15, determines whether or not a contact lens 3 is present in the receptacle 10. This determination can be performed, for example, by comparing the intensity of the detected UV-light 15 with a predefined threshold. The predefined threshold can be chosen such that the detected intensity of the UV-light 15 is sufficiently above the predefined threshold in case no contact lens 3 is present in the receptacle 10, and is sufficiently below the predefined threshold in case a contact lens 3 is present in the receptacle 10. The threshold can be predefined, for example, on the basis of one or more calibration measurements in which no contact lens 3 is present in the receptacle 10, and on the basis one or more calibration measurements in which a contact lens 3 is present in the receptacle 10. The predefined threshold is then set between these intensities (obtained from the calibration measurements with and without contact lens), so that once the predefined threshold has been set only a comparison of the actual intensity of the detected UV-light 15 with the predefined threshold must be performed to determine whether or not a contact lens 3 is present in the receptacle 10.

Alternatively, the intensity of the UV-light 14 of the UV-light source 11 irradiating the portion of the receptacle 10 can be adjusted such that in case a contact lens 3 is present in the receptacle 10 no detected UV-light 15 is detected by the detector 12, whereas in case no contact lens 3 is present in the receptacle 10, detected UV-light 15 can be detected by the detector 12.

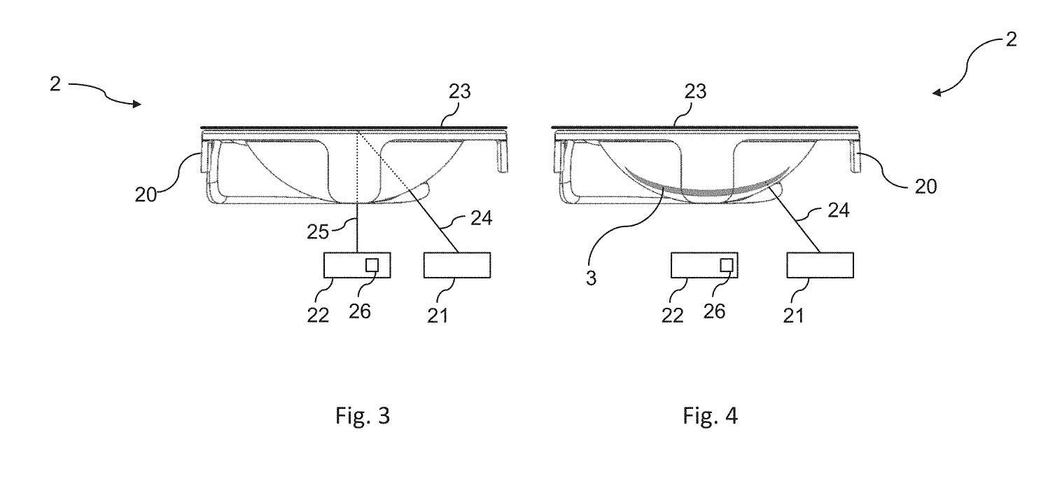

FIG. 3 and FIG. 4 illustrate a second embodiment of the method and a lens detection station 2 according to the invention. Some of the above discussed aspects related to the first embodiment also apply to the second embodiment. Thus, they are not discussed again. Concerning these aspects, reference is made to the description of the first embodiment.

In the second embodiment, the lens detection station 2 comprises a receptacle 20 for accommodating a contact lens 3, a UV-light source 21 and a detector 22. A removable cover 23 (for example an aluminum foil) which is non-transparent to UV-light is attached (e.g. laminated) onto a top surface of the receptacle 20 (see FIG. 3 and FIG. 4).

The UV-light source 21 and the detector 22 are both arranged beneath a bottom surface of the receptacle 20 in a manner such that the UV-light source 21 in operation irradiates with UV-light 24 a portion of the receptacle 20 where the contact lens 3 is supposedly accommodated. The detector 22 is arranged to detect UV-light 25 coming from the irradiated portion of the receptacle 20. The receptacle 20 is filled with liquid (e.g. saline).

The principle of operation is somewhat similar to that of the first embodiment, except that in the second embodiment detection is not performed in transmission. Instead, UV-light 25 coming back from the receptacle 20 is detected by the detector 22. In case no contact lens 3 is present in the receptacle 20, the UV-light 24 of the UV-light source 21 irradiating the portion of the receptacle 20 passes through the receptacle 20, is reflected or diffracted at the cover 23, and passes through the receptacle 20 again before the UV-light 25 coming from the receptacle 20 is detected by the detector 22. In case a contact lens 3 is present in the receptacle 20, the UV-light 24 of the UV-light source 20 passes through the contact lens 3, is reflected or diffracted at the cover 23 and passes again through the contact lens 3, so that either UV-light 25 of reduced intensity is detected by the detector 22, or no UV-light 25 is detected by the detector 22 (in the case that the UV-light has been completely absorbed by the contact lens 3), see FIG. 6. The evaluation component 26 of the detector 22 again determines the presence or absence of a contact lens 3 through comparison with a suitable predefined threshold, as has been described for the first embodiment.

Embodiments of the invention have been described above with the aid of the drawings, however, it is obvious that many changes and/or modifications are possible without departing from the teaching underlying the invention. Therefore, such changes or modifications are intended to be within the scope of protection which is defined by the appended claims.

1.-11. (canceled)

12. A method for detecting the presence or absence of an ophthalmic lens capable of absorbing UV-light, in a receptacle, the method comprising the steps of:
irradiating at least a portion of said receptacle where said ophthalmic lens is supposedly accommodated with UV-light, said receptacle having an absorbance for said UV-light which is significantly different from that of the ophthalmic lens,
detecting UV-light coming from said irradiated portion of said receptacle where said ophthalmic lens is supposedly accommodated,
analyzing said detected UV-light, and
from said analysis of said detected UV-light determining the presence or absence of a said ophthalmic lens in said receptacle.

13. The method according to claim 12, wherein said step of irradiating comprises irradiating said portion of said receptacle with radiation comprising UV-light of a wavelength in the range of 280 nm to 380 nm.

14. The method according to claim 12, wherein said step of irradiating is performed using a UV-laser.

15. The method according to claim 13, wherein said step of detecting UV-light is performed using a detector capable of detecting said UV-light of a wavelength in the range of 280 nm to 380 nm, wherein further said step of analyzing said detected UV-light comprises comparing the intensity of said detected UV-light of a wavelength in the range of 280 nm to 380 nm detected by said detector with a predefined threshold, and wherein in case the intensity of said detected UV-light of a wavelength in the range of 280 nm to 380 nm detected by said detector is less than said predefined threshold the presence of said ophthalmic lens is determined.

16. The method according to claim 14, wherein said step of detecting UV-light is performed using a detector capable of detecting said UV-light of a wavelength in the range of 280 nm to 380 nm, wherein further said step of analyzing said detected UV-light comprises comparing the intensity of said detected UV-light of a wavelength in the range of 280 nm to 380 nm detected by said detector with a predefined threshold, and wherein in case the intensity of said detected UV-light of a wavelength in the range of 280 nm to 380 nm detected by said detector is less than said predefined threshold the presence of said ophthalmic lens is determined.

17. The method according to claim 12, wherein said step of irradiating said portion of said receptacle with the said UV-light and said step of detecting said UV-light coming from the said irradiated portion of said receptacle are performed with said receptacle being filled with a liquid.

18. The method according to claim 13, wherein said step of irradiating said portion of said receptacle with the said UV-light and said step of detecting said UV-light coming from the said irradiated portion of said receptacle are performed with said receptacle being filled with a liquid.

19. The method according to claim 15, wherein said step of irradiating said portion of said receptacle with the said UV-light and said step of detecting said UV-light coming from the said irradiated portion of said receptacle are performed with said receptacle being filled with a liquid.

20. The method according to claim 12, wherein said portion of said receptacle is irradiated with said UV-light from beneath a bottom of said receptacle or from above a top surface of said receptacle, and wherein said UV-light coming from said portion of said receptacle is detected on a side of said receptacle opposite to that side from which said portion of said receptacle is irradiated.

21. The method according to claim 15, wherein said portion of said receptacle is irradiated with said UV-light from beneath a bottom of said receptacle or from above a top surface of said receptacle, and wherein said UV-light coming from said portion of said receptacle is detected on a side of said receptacle opposite to that side from which said portion of said receptacle is irradiated.

22. The method according to claim 12, wherein a removable cover which is non-transparent to said UV-light is attached to a top surface of said receptacle, and wherein both said step of irradiating said portion of said receptacle with said UV-light as well as said step of detecting said UV-light coming from said irradiated portion of said receptacle are performed from beneath a bottom of said receptacle.

23. The method according to claim 13, wherein a removable cover which is non-transparent to said UV-light is attached to a top surface of said receptacle, and wherein both said step of irradiating said portion of said receptacle with said UV-light as well as said step of detecting said UV-light coming from said irradiated portion of said receptacle are performed from beneath a bottom of said receptacle.

24. The method according to claim 14, wherein a removable cover which is non-transparent to said UV-light is attached to a top surface of said receptacle, and wherein both said step of irradiating said portion of said receptacle with said UV-light as well as said step of detecting said UV-light coming from said irradiated portion of said receptacle are performed from beneath a bottom of said receptacle.

25. The method according to claim 15, wherein a removable cover which is non-transparent to said UV-light is attached to a top surface of said receptacle, and wherein both said step of irradiating said portion of said receptacle with said UV-light as well as said step of detecting said UV-light coming from said irradiated portion of said receptacle are performed from beneath a bottom of said receptacle.

26. The method according to claim 17, wherein a removable cover which is non-transparent to said UV-light is attached to a top surface of said receptacle, and wherein both said step of irradiating said portion of said receptacle with said UV-light as well as said step of detecting said UV-light coming from said irradiated portion of said receptacle are performed from beneath a bottom of said receptacle.

27. The method to claim 12, wherein said receptacle is made of polypropylene.

28. A lens detection station for detecting the presence or absence of an ophthalmic lens capable of absorbing UV-light, in a receptacle, the lens detection station comprising a UV-light source which is arranged to in operation irradiate with UV-light at least a portion of said receptacle where said ophthalmic lens is supposedly accommodated, the lens detection station further comprising a detector capable of and arranged to in operation detect UV-light coming from said portion of said receptacle where said ophthalmic lens is supposedly accommodated, said detector further being adapted to analyze said detected UV-light and to determine from said analysis the presence or absence of a said ophthalmic lens in said receptacle.

29. The lens detection station according to claim 28, wherein said UV-radiation source is adapted to in operation irradiate said portion of said receptacle with UV-light of a wavelength in the range of 280 nm to 380 nm, and wherein said detector is capable of detecting UV-light of a wavelength in said range of 280 nm to 380 nm.

30. The lens detection station according to claim 28, wherein said UV-radiation source is a UV-laser.

31. The lens detection station according to claim 29, wherein said UV-radiation source is a UV-laser.
